(19) United States
(12) Patent Application Publication
(10) Pub. No.: US 2013/0295791 A1
(43) Pub. Date: Nov. 7, 2013

(54) CONNECTOR

(71) Applicant: Yoji KUTSUNA, Makinohara-shi (JP)

(72) Inventor: Yoji KUTSUNA, Makinohara-shi (JP)

(73) Assignee: YAZAKI CORPORATION, Tokyo (JP)

(21) Appl. No.: 13/939,758

(22) Filed: Jul. 11, 2013

Related U.S. Application Data
(63) Continuation of application No. PCT/JP2011/006803, filed on Dec. 5, 2011.

(30) Foreign Application Priority Data
Jan. 12, 2011 (JP) 2011-004112

(51) Int. Cl. H01R 13/642

(52) U.S. Cl. CPC H01R 13/642
USPC 439/374

(57) ABSTRACT

A connector comprises: a female terminal configured to connect to a male terminal being inserted thereinto, the female terminal having a first guide surface at an end portion thereof on a fitting surface side to the male terminal, the first guide surface being configured to guide a front end portion of the male terminal to a regular insertion position thereof; and a connector housing having: a terminal accommodation chamber configured to accommodate the female terminal, having an opening into which the male terminal is inserted; and a second guide surface at an peripheral edge of the opening of the terminal accommodation chamber, being configured to guide the front end portion of the male terminal to the regular insertion position.

### CROSS REFERENCE TO RELATED APPLICATIONS

This application is a continuation application of International Application No. PCT/JP2011/006803, filed on Dec. 5, 2011, which claims priority to Japanese Patent Application No. 2011-004112, filed on Jan. 12, 2011, the entire contents of which are incorporated by references herein.

### BACKGROUND OF THE INVENTION

1. Field of the Invention

The present invention relates to a connector configured to guide a male terminal to an insertion position of a terminal accommodation chamber.

2. Description of the Related Art

In a connector housing having a terminal accommodation chamber and a female terminal accommodated therein, a male terminal as a corresponding terminal of the female terminal is inserted from an opening (an insertion opening) at a front end portion of the terminal accommodation chamber to connect to the female terminal.

In order to guide the male terminal to be linearly inserted, the terminal accommodation chamber has a terminal guide surface at the opening. In general, the terminal guide surface is formed in a tapered shape.

FIGS. 1 and 2 show a connector 100 that includes a terminal guide surface disclosed in Japanese Patent Application Laid-Open No. 2004-152583. The connector 100 includes a connector housing 120 shown in FIG. 1 and a retainer 130 shown in FIG. 2 which is fitted to the front side of the connector housing 120. The connector housing 120 is provided with a plurality of terminal accommodation chambers 110 each for accommodating the female terminal therein.

As shown in FIG. 1, an opening 111 is formed in the front end portion of the terminal accommodation chamber 110. A male terminal as the corresponding terminal of the female terminal is inserted into the opening 111. A male terminal guide surface 113 is formed in the peripheral edge portion of the opening 111. The male terminal guide surface 113 has a tapered shape. The male terminal guide surface 113 is formed in the left, right and upper edge portions of the opening 111. In the lower edge portion of the opening 111, an opening groove 117 is formed. The opening groove 117 corresponds to a locking lance 115.

The retainer 130 is provided with window holes 131 which respectively correspond to the terminal accommodation chambers 110. An auxiliary plate 133 protrudes from the lower edge of each window hole 131, and an auxiliary guide surface 135 is formed in the upper end portion of the auxiliary plate 133. Further, each window hole 131 is provided with a hole 137 into which a release tool is inserted. When the retainer 130 is fitted into the front end portion of the connector housing 120, the auxiliary guide surface 135 is positioned at the opening groove 117. Accordingly, the terminal guide surface is formed in the edge portion of the entire periphery (that is, four surfaces) of the opening 111 by the auxiliary guide surface 135 and the male terminal guide surface 113 of the connector housing 120.

### SUMMARY OF THE INVENTION

In the above-described connector, the opening groove 117 for the locking lance 115 is formed in the terminal accommodation chamber 110, and the hole 137 is formed in the retainer 130. Accordingly, the strength of the terminal guide surface formed by the terminal accommodation chamber 110 and the retainer 130 is small. Further, the opening groove 117 and the hole 137 are needed, and the retainer 130 is needed in order to form the terminal guide surface in the entire periphery of the opening 111. Accordingly, the number of components of the connector increases, and a decrease in the size of the connector housing is not easy to be attained.

It is an object of the invention to provide a connector capable of improving the strength of a terminal guide surface, decreasing the number of components, and reducing the size thereof.

An aspect of the present invention is a connector comprising: a female terminal configured to connect to a male terminal being inserted thereinto, the female terminal having a first guide surface at an end thereof on a fitting surface side to the male terminal, the first guide surface being configured to guide a front end portion of the male terminal to a regular insertion position thereof; and a connector housing having: a terminal accommodation chamber configured to accommodate the female terminal, having an opening into which the male terminal is inserted; and a second guide surface at an peripheral edge of the opening of the terminal accommodation chamber, being configured to guide the front end portion of the male terminal to the regular insertion position.

The second guide surface may include: a lower surface and a pair of side surfaces provided at both sides of the lower surface, and the first guide surface may be provided at a position facing the lower surface.

The first guide surface may be positioned at an outside of the terminal accommodation chamber.

According to the invention, it is possible to provide a connector capable of improving the strength of a terminal guide surface, decreasing the number of components, and reducing the size thereof.

### BRIEF DESCRIPTION OF THE DRAWINGS

FIG. 1 is a front view illustrating a connector of the related art.

FIG. 2 is a front view illustrating a retainer used in the connector of the related art.

FIG. 3 is an overall perspective view illustrating an embodiment of a present invention.

FIG. 4 is a cross-sectional view illustrating the embodiment.

FIG. 5 is a front view illustrating the embodiment.

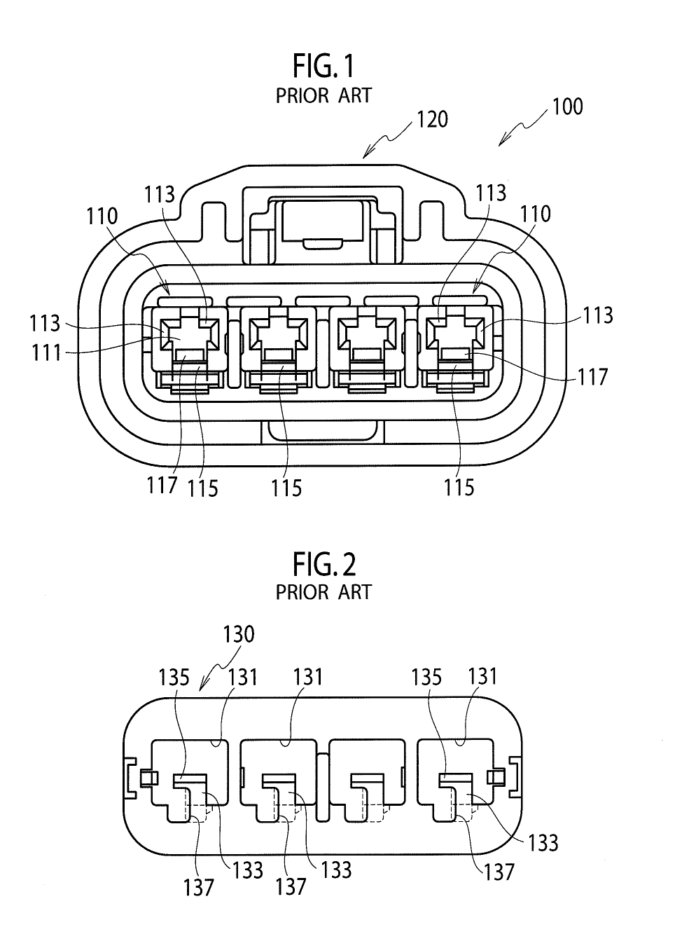

### DESCRIPTION OF THE PREFERRED EMBODIMENTS

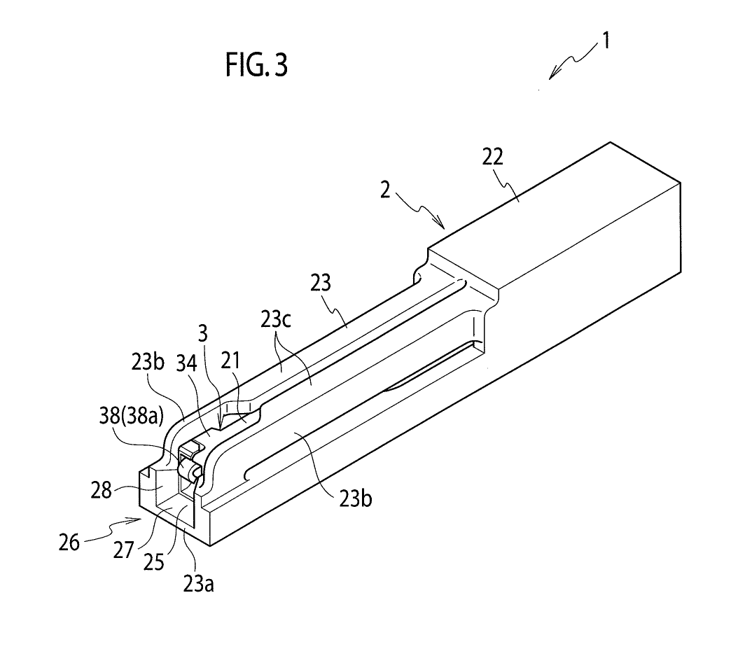

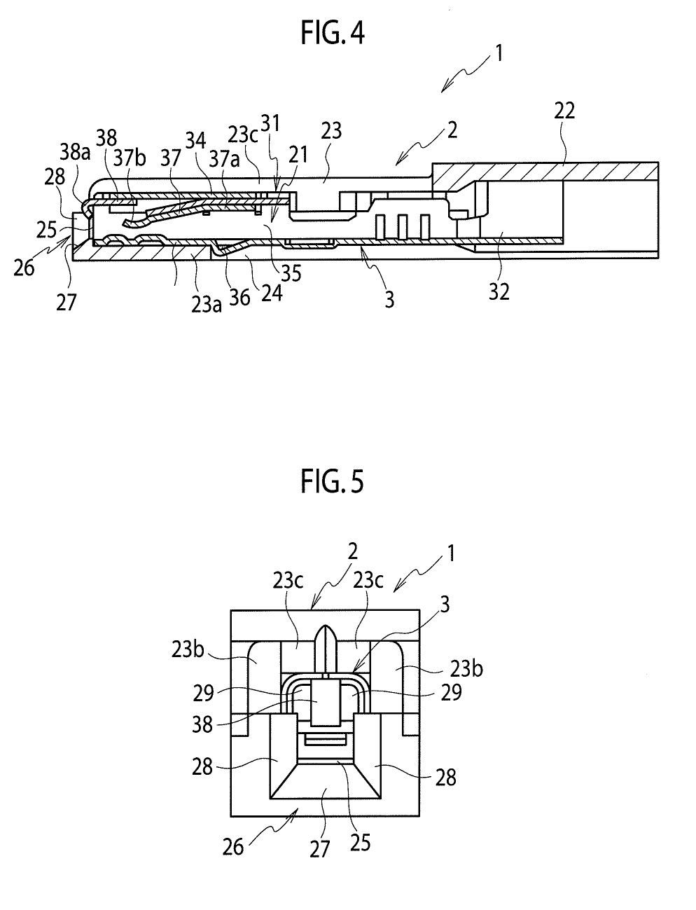

Hereinafter, an embodiment of the present invention will be described with reference to drawings. FIG. 3 is a perspective view illustrating a connector 1 according to an embodiment of the present invention. FIG. 4 is a vertical sectional view illustrating the connector 1. FIG. 5 is a front view illustrating the connector 1.

The connector 1 includes a connector housing 2 and a female terminal 3. A male terminal (not shown), which is the corresponding terminal of the female terminal 3, is inserted into the connector housing 2.

The connector housing 2 has a terminal accommodation chamber 21 into which the female terminal 3 is inserted to be accommodated. The terminal accommodation chamber 21 is entirely formed of an insulating resin. The terminal accommodation chamber 21 includes a terminal insertion portion 22 and a terminal accommodation portion 23. The terminal insertion portion 22 is formed in a hollow cylindrical shape with a rectangular cross section, and the female terminal 3 is inserted into the terminal insertion portion 22. The terminal accommodation portion 23 accommodates the female terminal 3 which is inserted through the terminal insertion portion 22. For example, the terminal accommodation portion 23 accommodates mainly the front end portion of the female terminal 3 and the peripheral portion thereof. The terminal accommodation portion 23 is formed extending from one side of the terminal insertion portion 22 to form one side (the front end side) of the terminal accommodation chamber 21.

The terminal accommodation portion 23 includes a bottom wall portion 23a, left and right side wall portions 23b which are uprightly stand at left and right edges of the bottom wall portion 23a, and top wall portions 23c which are bent from the upper end portions of the left and right side wall portions 23b so as to be close to each other. An end portion of the terminal accommodation portion 23 is positioned at a side opposite to a side at which the terminal accommodation portion 23 connects to the terminal insertion portion 22. The end portion is provided with an opening 25 through which the male terminal is inserted into the terminal accommodation chamber 21. The opening 25 is formed in a rectangular shape, and the peripheral edge portion thereof is provided with a male terminal guide surface (a second guide surface) 26.

As shown in FIG. 5, the male terminal guide surface 26 includes three surfaces: a lower surface 27 and a pair of side surfaces 28 provided at both sides of the lower surface 27. The lower surface 27 and the pair of side surfaces 28 are formed as tapered surfaces which are inclined so as to decrease an area of the opening 25 toward the inside of the terminal accommodation portion 23. The male terminal guide surface 26 guides a tab (not shown) of a front end of the male terminal inserted from the opening 25 to a regular insertion position. The regular insertion position herein indicates a position where the tab of the male terminal is inserted into the female terminal 3 and the tab comes into contact with an elastic contact piece 37 (refer to FIG. 4) of the female terminal 3 to be described later.

The terminal insertion portion 22 includes a locking lance (not shown) inside which is locked to the female terminal 3. The locking lance is formed so as to protrude into the terminal insertion portion 22. When the locking lance is locked to the female terminal 3, the female terminal 3 is prevented from coming off from the terminal accommodation chamber 21. The locking lance is bent in the direction (the outward direction) intersecting the insertion direction of the female terminal 3 in a state where the female terminal 3 starts to be inserted into the terminal accommodation chamber 21. Then, when the female terminal 3 is completely inserted into the terminal accommodation chamber 21, the locking lance returns to the original state so as to be locked to the female terminal 3.

As shown in FIG. 4, the female terminal 3 includes a contact portion 31 which is inserted into the terminal insertion portion 22 of the terminal accommodation chamber 21. The back side (the right side of FIG. 4) of the contact portion 31 is integrally formed with a wire-crimping portion 32 which electrically connects to a wire (not shown) by crimping.

The contact portion 31 of the female terminal 3 is formed in a rectangular and cylindrical shape that includes a bottom plate portion 33, an upper plate portion 34 facing the bottom plate portion 33, and a pair of left and right side plate portions 35 connecting the bottom plate portion 33 and the upper plate portion 34 to each other. The bottom plate portion 33 is provided with a locking convex portion 36. The locking convex portion 36 is locked to a locking hole portion 24 which is formed in the bottom wall portion 23a of the terminal accommodation chamber 21 (the terminal accommodation portion 23). The upper plate portion 34 is provided with an elastic contact piece 37. The elastic contact piece 37 is a cantilever that includes a base end portion 37a connected to the upper plate portion 34 and a front end portion 37b formed as a free end. The elastic contact piece 37 is electrically connected to the male terminal when the front end portion 37b comes into contact with the tab of the male terminal.

Furthermore, the female terminal 3 includes a male terminal guide surface (a first guide surface) 38 which is connected to the upper plate portion 34 . The male terminal guide surface 38 is formed so as to extend from the front end portion of the upper plate portion 34 toward the opening 25 of the terminal accommodation chamber 21. Accordingly, the male terminal guide surface 38 is positioned at the end of the female terminal 3 on a fitting surface side to the male terminal. Since the male terminal guide surface 38 is connected to the upper plate portion 34, the male terminal guide surface 38 is positioned so as to face the lower surface 27 in the male terminal guide surface 26.

Likewise, the male terminal guide surface 38 forms a male terminal guide surface having four surfaces with respect to the peripheral edge portion of the opening 25 together with the male terminal guide surface 26 formed in the opening 25 of the terminal accommodation chamber 21. Accordingly, the tab of the male terminal may be reliably guided to the regular insertion position.

The male terminal guide surface 38 includes a front end portion 38a which is bent toward the lower surface 27. Furthermore, the front end portion 38a is curved toward the wire-crimping portion 32, and its curvature guides the tab of the male terminal inserted in the opening 25 to the regular insertion position. That is, the front end portion 38a of the male terminal guide surface 38 guides the male terminal into the connector housing 2 so that the tab of the male terminal is inserted into the contact portion 31 of the female terminal 3 and the tab comes into contact with the elastic contact piece 37 of the female terminal 3. With the curvature of the front end portion 38a, the male terminal guide surface 38 guides the tab so that the tab of the male terminal does not bump against the elastic contact piece 37. Accordingly, the tab may be smoothly guided into the contact portion 31.

As shown in FIGS. 3 and 4, the front end portion 38a is positioned at an outside of the front end portion of the terminal accommodation chamber 21. That is, the front end portion 38a is exposed to the outside from the opening 25 of the terminal accommodation chamber 21. Accordingly, a check pin (not shown) can contact to the front end portion 38a from the outside. That is, the continuity test can be more easily and reliably performed compared to the other cases.

As shown in FIG. 5, the male terminal guide surface 38 has a width smaller than the transverse width (that is, the gap between two side wall portions 23b and 23b) of the opening 25 of the terminal accommodation chamber 21. Further, insertion holes 29 are formed at both left and right sides of the male terminal guide surface 38 so as to insert a release tool (not shown) thereinto. The release tool inserted into the insertion holes 29 comes into contact with the locking lance inside the terminal accommodation chamber 21 (the terminal accommodation portion 23), so that the locking lance is bent in the lock releasing direction due to the contact. That is, there is no need to form a hole, a groove, a recess, or the like in the connector housing 2 (the terminal accommodation portion 23) so as to insert the release tool (not shown) thereinto. Further, the locking state of the locking lance may be easily released by the operation.

In the embodiment, the male terminal guide surface 26 is formed in the peripheral edge portion of the opening 25 of the terminal accommodation chamber 21, and the male terminal guide surface 38 is formed in the end surface on the male terminal fitting surface side of the female terminal 3. Accordingly, the tab of the male terminal may be guided to the regular insertion position. That is, the connector housing 2 does not need to have a structure having the same function as that of the male terminal guide surface 38. Accordingly, since such a structure is not needed, the connector housing 2 may be decreased in size. Further, in the embodiment, a retainer for forming the male terminal guide surface is not also needed. Accordingly, it is possible to decrease the number of components and decrease the size of the entire connector. Furthermore, since the male terminal guide surface 38 is formed in the female terminal 3, the male terminal guide surface 38 is formed of metal. Accordingly, it is possible to improve the strength of the male terminal guide surface. Furthermore, the continuity test can be performed just by bringing the check pin into contact with the metallic male terminal guide surface 38, and the continuity test may be easily and accurately performed.

In the embodiment, the male terminal guide surface 26 is formed by the lower surface 27 and the pair of side surfaces 28 provided at both sides of the lower surface 27, and the male terminal guide surface 38 is provided at a position facing the lower surface 27. Accordingly, the male terminal guide surface may be formed in the entire periphery (four surfaces) of the peripheral edge portion of the insertion opening of the male terminal, whereby the male terminal may be guided to the regular insertion position with high precision.

Furthermore, since the male terminal guide surface 38 is positioned at the outside of the terminal accommodation chamber 21, the check pin may be easily brought into contact with the male terminal guide surface 38, and the continuity test may be easily performed.

What is claimed is:

1. A connector comprising:
a female terminal configured to connect to a male terminal being inserted thereinto, the female terminal having:
a contact portion into which the male terminal is inserted, the contact portion being formed into a cylindrical shape; and
a first guide surface connected to an inner surface of the contact portion at an end portion thereof on a fitting surface side to the male terminal, the first guide surface being curved inward to the inside of the contact portion to guide a front end portion of the male terminal to a regular insertion position thereof; and
a connector housing having:
a terminal accommodation chamber configured to accommodate the female terminal, having an opening into which the male terminal is inserted; and
a second guide surface at an peripheral edge of the opening of the terminal accommodation chamber, being configured to guide the front end portion of the male terminal to the regular insertion position
wherein the first guide surface is positioned at an outside of the terminal accommodation chamber.

2. The connector according to claim 1,
wherein the second guide surface including: a lower surface and a pair of side surfaces provided at both sides of the lower surface, and the first guide surface is provided at a position facing the lower surface.
